(19) United States
(12) Patent Application Publication
(10) Pub. No.: US 2026/0208147 A1
(43) Pub. Date: Jul. 23, 2026

(54) MIXING REACTORS

(71) Applicant: PROMETHEAN PARTICLES LTD, Nottingham (GB)

(72) Inventor: Edward Henry Lester, Nottingham (GB)

(73) Assignee: PROMETHEAN PARTICLES LTD, Nottingham (GB)

(21) Appl. No.: 19/144,310

(22) PCT Filed: Dec. 22, 2023
(86) PCT No.: PCT/EP2023/087751

§ 371 Date: Jun. 27, 2025

(30) Foreign Application Priority Data
Dec. 30, 2022 (GB) 2219837.8

(51) Int. Cl. B01J 19/24; B01F 25/00; B01F 25/10; B01F 35/93; B01F 101/00; B01J 19/00

(52) U.S. Cl. CPC B01J 19/244; B01F 25/102; B01F 35/93; B01J 19/0013; B01J 19/2405; B01J 19/245; B01F 2025/913; B01F 2101/2204; B01J 2219/24

(57) ABSTRACT

A mixing reactor comprising a first body comprising two or more inlets and an outlet, and a second body placed concentrically inside the first body so as to define an inner passage formed by an inner surface of the first body and an outer surface of the second body, wherein the inner passage extends along a length of the first body, wherein the two or more inlets are spaced along the length of the first body, and wherein there is no mixing between a liquid passed through the second body and a liquid passing through the inner passage.

### FIELD OF THE INVENTION

The present invention relates to mixing reactors such as may (non-exclusively) be suitable for producing particles such as nanoparticles or Metal-Organic Frameworks (MOFs), a cascade of such reactors and a method of using such reactors to mix fluids, typically but non-exclusively so as to produce such particles.

### BACKGROUND TO THE INVENTION

Metal and metal oxide particles with nanometre scale dimensions have a wide range of uses, including (but not limited to) catalysts, pigments, polishes, ultraviolet absorbers and in ceramics. It is well known that such particles can be formed by chemical reaction of aqueous solutions of metal salts with heated, pressurised or supercritical water. In principle, this methodology offers distinct advantages over other methods of nanoparticle creation in terms of cost and viability as it allows the reaction to be performed as a continuous process. However, it is difficult to perform this reaction on a commercial scale utilising current methods, because existing reactor configurations do not allow the precipitation reaction to be controlled effectively leading to frequent blockage of the reactor and inadequate control of particle size and shape. Hence within this process, the design of the reactor where the water and the salt solution mix is of crucial importance to the size and properties of the nanoparticles produced. Furthermore, current reactors effectively limit the concentration of reactants that can be used (and so the rate at which products can be created with the reactor) as they will either block up with product, or not sufficiently mix the reactants.

The PCT patent application published as WO2005/077505 describes a counter-current mixing reactor where supercritical water is introduced into a first inlet and a metal salt solution is introduced at a second inlet, the resultant nanoparticle-bearing suspension being extracted at an outlet. In this case, the first inlet is positioned within the outlet, so that the mixing occurs where the flow of supercritical water changes direction through 180 degrees. WO2014/111703 and WO2015/075439 both disclose a mixing reactor where a first fluid is flowing in a conduit, and a second fluid is introduced into that flow perpendicularly to the flow.

We are also aware of the PCT patent application publication WO2013/034632, which discloses a mixing reactor that introduces the supercritical water parallel to the flow of the metal salt solution, then uses mechanical impellers to achieve mixing.

We are also aware of the PCT patent application publication WO2011/148121, which discloses a co-current mixer, where the metal salt solution is introduced through two opposing inlets having a common outlet, and supercritical water is introduced through a third inlet within the outlet, such that the metal salt solution and the supercritical water introduced at their respective inlets flow in the same direction through the outlet. However, we have appreciated that this leads to preheating of the metal salt solution prior to the mixing point (as the inlet for the supercritical fluid necessarily must pass through the flow of metal salt solution) and consequent cooling of the supercritical water, which can lead to a rapid drop in the buoyancy of the outflow and to difficulties in ensuring a symmetrical flow in the outlet, as the supercritical water inlet cannot be long enough to ensure a satisfactorily symmetrical flow without leading to an unacceptable pre-mixing heat transfer from the supercritical water to the metal salt solution.

It has also been noted that when existing continuous-flow reactor designs are run at higher flow rates, and or higher concentrations, there is little control over the particle sizes of the nanoparticles or MOFs being produced.

Thus, the present invention provides a mixing reactor for the preparation of metal-organic frameworks (MOF) which can be run at higher total flow rates without MOF product blocking the reactor and can provide a higher control over particle size especially at high concentrations of reactants or MOFs without blocking or dissolution issues.

### SUMMARY OF THE INVENTION

In a first aspect the invention provides a mixing reactor comprising: a first body comprising two or more inlets and an outlet, and a second body placed concentrically inside the first body so as to define an inner passage formed by an inner surface of the first body and an outer surface of the second body, wherein the inner passage extends along a length of the first body.

In a second aspect there is provided a cascade of mixing reactors, comprising a first mixing reactor in accordance with the first aspect of the invention and a second mixing reactor in accordance with the first aspect of the invention, in which the outlet of the first body of the first mixing reactor is coupled to an inlet of the first body of the second mixing reactor.

In a third aspect the invention provides a method of mixing two fluids, comprising delivering a first fluid through one inlet of the first body of a mixing reactor in accordance with the first aspect of the invention, delivering a second fluid through one or more other inlets of the first body of said mixing reactor and extracting a mixed fluid from the outlet.

According to a fourth aspect of the invention, there is provided a method of mixing two solutions, comprising introducing a first solution to a first inlet of a first reactor and a second solution to a second inlet of the first reactor, to produce a first mixed fluid at an outlet of the first reactor, and conveying the first mixed fluid to a first inlet of a second reactor and introducing further second solution to a second inlet of the second reactor, in which the concentrations of the second fluid introduced to the first and second reactors is different.

### DETAILED DESCRIPTION

According to a first aspect, the present invention provides a mixing reactor, the reactor comprising a first body comprising two or more inlets and an outlet, and a second body placed concentrically inside the first body so as to define an inner passage formed by an inner surface of the first body and an outer surface of the second body, wherein the inner passage extends along a length of the first body.

In the context of the present invention concentrically or concentric means having a common centre or common axis. Thus, when the second body is concentrically inside the first body, the second body and the first body have the same centre or share a common axis.

The second body may have an inlet and an outlet. Said inlet may be at a first end of the second body and the outlet may be at a second end of the second body. The inlet and outlet of the second body may be outside the inner passage. The second body is generally elongate and has a length.

The second body may be a pipe. The second body may be made of a metal material or a suitable polymeric material. The second body may be a metal pipe such as a copper or stainless steel pipe.

A heated or cooled liquid may pass through the second body to control the core temperature. Said core temperature may be from −20° C. to 350° C., or 0° C. to 100° C. The heated or cooled liquid may enter the second body through the inlet of the second body and exit the second body through the outlet of the second body.

The second body is placed centrally or concentrically within the first body.

The first body is generally elongate and has a length. The first body may be a pipe. The first body may be a clear pipe. The first body may be a PVC pipe or may be made of other suitable polymeric materials. The first body may be a metal pipe, such as a copper or stainless steel pipe.

The first body has an inner surface. The first body may have an outer surface.

The inner passage formed by the inner surface of the first body and the outer surface of a second body creates a continuous void. The inner passage runs along the length of the first body. The length of the inner passage may be the same or smaller than the length of the first body. The inner passage may run from the first inlet at a first end of the first body to the outlet at a second end of the first body.

The inner passage may have a width defined by the distance from the inner surface of the first body to the outer surface of the second body. The width of the passage may be constant along its length. The width of the passage may be from 1 to 150 mm, such as from 1 to 100 mm, or from 1 to 50 mm.

The mixing reactor comprises a first body comprising two or more inlets and an outlet. Said first body may have a first inlet typically at a first end of the first body and an outlet typically at a second end of the first body.

The two or more inlets of the first body allow liquids to be pumped into the inner passage formed by an inner surface of the first body and an outer surface of the second body along the length of the first body.

The first body may comprise two or more inlets, or three or more inlets, such as four or more inlets, or five or more inlets, or six or more inlets, or seven or more inlets. The first body may comprise from 2 to 10 inlets, preferably from 2 to 9 inlets, or from 2 to 8 inlets, or from 2 to 7 inlets, or from 2 to 6 inlets, or from 2 to 5 inlets, or from 2 to 4 inlets or from 2 to 3 inlets.

The first body may have at least one further outlet.

The reactor of the present invention may comprise a first body comprising a first inlet and a second inlet and an outlet. The first body may comprise a first inlet, a second inlet, a third inlet and an outlet. The first body may comprise a first inlet, a second inlet, a third inlet, a fourth inlet and an outlet. The first body may comprise a first inlet, a second inlet, a third inlet, a fourth inlet, a fifth inlet and an outlet. Said first inlet may be at a first end of the first body and the outlet may be at a second end of the first body.

In one embodiment of the present invention the two or more inlets of the first body are axially aligned on the first body. The two or more inlets and the outlet may be axially aligned.

The first body may comprise two or more inlets, such as a first inlet, a second inlet, a third inlet, a fourth inlet and a fifth inlet consecutively and axially aligned along the length of the first body.

In one embodiment of the present invention each inlet may be arranged to introduce fluid into the passage at least partially tangentially relative to the common axis. Each inlet may be arranged to introduce fluid into the passage within 15, 10, 5 or 1 degrees of tangential relative to the axis.

Because the fluids are being introduced through two or more inlets which introduce fluid at least partially tangentially and/or are axially aligned in the first body, a turbulent swirling flow of the reactant mixture within the inner passage will be created, which flows toward the outlet of the first body. This achieves an efficient mixing without the need for mechanical mixing means or so on.

The two or more inlets may be spaced along the length of the first body. The two or more inlets may be axially spaced along the length of the first body. The two or more inlets may be axially aligned and spaced along the length of the first body. The two or more inlets which introduce fluid at least partially tangentially and/or are axially aligned and spaced along the length of the first body allow the fluid to be fed into the inner passage of the mixing reactor to create a swirling flow.

In one embodiment, the distance between inlets along the length of the first body may increase moving towards the outlet, so the distance between the first inlet and the second inlet may be smaller than the distance between the second inlet and the third inlet, and the distance between the second inlet and the third inlet may be smaller than the distance between the third inlet and the fourth inlet, and the distance between the third inlet and the fourth inlet may be smaller than the distance between the fourth inlet and the fifth inlet.

The distance between the first inlet and the second inlet may be from 1 to 25 cm.

In one embodiment the reactor of the present invention comprises a first body comprising four inlets and an outlet, wherein the four inlets are arranged to introduce fluid into the passage at least partially tangentially relative to the common axis and are axially aligned and spaced along the first body, wherein the first inlet is at the first end of the first body and an outlet is at the second end of the first body.

In one embodiment the reactor of the present invention comprises a first body comprising five inlets and an outlet, wherein the five inlets are arranged to introduce fluid into the passage at least partially tangentially relative to the common axis and are axially aligned and spaced along the first body, wherein the first inlet is at the first end of the first body and an outlet is at the second end of the first body.

The outlet of the first body allows for the collection of liquid (e.g. reaction product) from the inner passage.

There is no mixing between the liquid (e.g. coolant or heating) passed through the second body, and the liquid flowing/swirling within the inner passage.

The reactor may be suitable for mixing two fluids. Typically, it will be suitable for forming particles, such as nanoparticles or metal-organic framework (MOF) particles.

A first fluid and a second fluid may be introduced or pumped into the inner passage through the two or more inlets of the first body. Each of the first and second fluids may be introduced or pumped through a different inlet of the first body.

The first fluid may be a metal salt solution. The metal salt solution may be, for example, a solution of metal nitrates, metal sulfates, metal acetates, metal acetylacetonates, metal halides, or metal carbonates, and more particularly may be any of iron nitrate, iron acetate, iron sulfate, aluminium nitrate, zinc nitrate, copper nitrate, copper acetate, nickel nitrate, calcium acetate, calcium nitrate, barium nitrate, cobalt acetate, titanium bis(ammonium lactato)dihydroxide, titanium tetrachloride, platinum nitrate, palladium nitrate, cerium nitrate or others. The first fluid may additionally comprise a base, such as sodium hydroxide, potassium hydroxide, amines (e.g. triethylamine) or a combination thereof.

The second fluid may comprise a ligand solution, such as terepthalic acid, citric acid, fumaric acid, isopthalic acid, dihydroxyisophthalic acid, trimesic acid, 2-methylimidazole, 2-aminoterephthalic acid, 2,5-dihydroxyterephthalic acid or Pyrazole-2,5-dicarboxylic acid. The second fluid may additionally comprise a base to deprotonate the ligand, such as sodium hydroxide, potassium hydroxide, amines (e.g. triethylamine) or a combination thereof.

More than two different fluids (e.g. a third reactant solution) may be introduced or pumped into the inner passage through the two or more inlets of the first body.

For example, a third fluid may be introduced or pumped into the inner passage through the two or more inlets of the first body. The third fluid may be, for example, a secondary metal salt solution, or a solution containing a “capping agent”, including but not limited to organic acids (e.g. citric acid), thiols (e.g. methanethiol) and polymers (e.g. polyvinylpyrrolidone). Alternatively, it could be the same fluid as the first or second fluid, but at a different concentration, or could be a basic solution (e.g. Sodium Hydroxide NaOH) to deprotonate the ligand.

The first fluid may be introduced or pumped into the inner passage through the first inlet at the first end of the first body. The second fluid may be introduced or pumped into the inner passage through the second inlet of the first body.

In one embodiment the first body may comprise three or more inlets, so the first fluid may be introduced or pumped into the inner passage through the first inlet at the first end of the first body and the second fluid may be introduced or pumped into the inner passage through the second and subsequent inlets.

The first fluid may be introduced or pumped into the inner passage through the first inlet of the first body and the second fluid may be introduced or pumped into the inner passage through the second inlet, or through the second and third inlets, or through the second, third and fourth inlets, or through the second, third, fourth and fifth inlets of the first body.

The mixing reactor of the present invention may be operated at at least 1 L/min, 10 L/min or 100 L/min flow rate measured at the outlet.

According to a second aspect of the invention, there is provided a cascade of mixing reactors, comprising a first mixing reactor in accordance with the first aspect of the invention and a second mixing reactor in accordance with the first aspect of the invention, in which the outlet of the first body of the first mixing reactor is coupled to an inlet of the first body of the second mixing reactor.

The outlet of the first body of the first mixing reactor may be coupled to a first inlet of the first body of the second mixing reactor. The outlet of the first body of the first mixing reactor may be coupled to a first and/or second inlet of the first body of the second mixing reactor.

In one embodiment the outlet of the first body of the first mixing reactor is coupled to the first inlet at a first end of the first body of the second mixing reactor and an additional fluid (e.g. a metal salt solution or a ligand solution) may be introduced or pumped into the inner passage of the first body of the second mixing reactor through the second or subsequent inlets of the first body of the second mixing reactor.

According to a third aspect of the invention, there is provided a method of mixing two fluids comprising delivering a first fluid through one inlet of the first body of a mixing reactor in accordance with the first aspect of the invention, delivering a second fluid through one or more inlets of the first body of said mixing reactor and extracting a mixed fluid from the outlet.

The first fluid may comprise a metal salt solution. The second fluid may comprise a solution, such as a ligand solution. The concentration of the solution forming the second fluid may vary at different inlets of the first body.

This has been found to be a particularly efficient way of mixing two fluids. Typically, any or the first, second or mixed fluids can be liquids, including solutions or suspensions.

In the method of the present invention the first and second fluids are delivered through different inlets.

In the method of the present invention the first fluid may be delivered through a first inlet at the first end of the first body of a mixing reactor in accordance with the first aspect of the invention, and the second fluid may be delivered through the remaining inlets, or a second inlet, or through a second and a third inlet, or through a second, a third and a fourth inlet, or through a second, third, fourth and fifth inlet of the first body of the mixing reactor and the mixed fluid is extracted through the outlet of the first body.

The method of the present invention may also comprise delivering a third fluid through one or more inlets of the first body. The first, second and third fluids may be delivered through different inlets. The third fluid may be, for example, a secondary metal salt solution, or a solution containing a “capping agent”, including but not limited to organic acids (e.g. citric acid), thiols (e.g. methanethiol), amines (e.g. ethylenediamine) and polymers (e.g. polyvinylpyrrolidone).

The method may comprise passing the mixed fluid through a further mixing reactor in accordance with the first aspect of the invention, in which the mixed fluid is introduced to an inlet of the first body of the further mixing reactor and an additional fluid is introduced at an inlet of the first body of the further mixing reactor and a further mixed fluid is extracted at the outlet of the further mixing reactor. The additional fluid may be the first, second or third fluids described herein.

The mixed fluid may be a particle-bearing suspension. Thus, the mixing reactor will mix the first and second fluids (or third), so that they mix together and particles form. As discussed above, the mixing will be efficient due to the swirl induced in the flow.

The method may comprise heating or cooling the mixed fluid as it passes or swirls through the inner passage formed by an inner surface of the first body and an outer surface of the second body.

The mixing reactor and the further mixing reactor may form a cascade in accordance with the second aspect of the invention.

The particles may be nanoparticles, or metal-organic framework (MOF) particles, or other suitable particles that can be formed by combining a metal salt solution with the fluid.

The reactors and methods of the present invention provide improved control in MOF particle production over current reactors, allowing for finer control of particle size and/or an increase in MOF precursors and resulting product concentration.

For example, with the reactors and methods of the present invention higher flow rates (or higher concentrations of the first and second fluids) are possible without MOF product blocking the reactor. The reactors and method of the present invention may be capable of running at higher total flow rate than existing reactor designs, for example 10 L/min.

It was also noticed that higher concentrations are also possible without blocking or dissolution issues. The presence of two or more inlets, preferably three inlets, and more preferably four or five inlets mean reagents with higher solubilities can be placed in a single feed and lower solubility reagents can be placed in multiple feeds at lower concentrations.

The reactors and method of the present invention also produce larger particles due to sequential addition of one of the two main reagents (metal or ligand) this favours particle growth over nucleation leading to larger particles.

According to a fourth aspect of the invention, there is provided a method of mixing two solutions, comprising introducing a first solution to a first inlet of a first reactor and a second solution to a second inlet of the first reactor, to produce a first mixed fluid at an outlet of the first reactor, and conveying the first mixed fluid to a first inlet of a second reactor and introducing further second solution to a second inlet of the second reactor, in which the concentrations of the second fluid introduced to the first and second reactors is different.

As such, this allows for the second fluid to react with the first fluid in sufficient quantities to react but without clogging the reactors or reducing the efficiency of mixing as a result of the increasing density of particles around each progressive inlet.

The method may have any of the optional features of the fourth aspect of the invention.

### DESCRIPTION OF THE DRAWINGS

A number of embodiments of the invention will now be further described, by means of example only, with reference to the drawings, in which:

FIG. 1 shows a side view of the mixing reactor according in accordance with a first embodiment of the invention.

FIG. 2 shows a schematic cross section through the mixing reactor of FIG. 1.

FIG. 3 shows views of both ends of a mixing reactor according to the invention.

FIG. 4 shows scanning electron micrographs of particles produced by a mixing reactor according to the invention and a prior art reactor.

FIG. 5 shows BET Isotherm adsorption graphs of particles produced by a mixing reactor according to the invention and a prior art reactor.

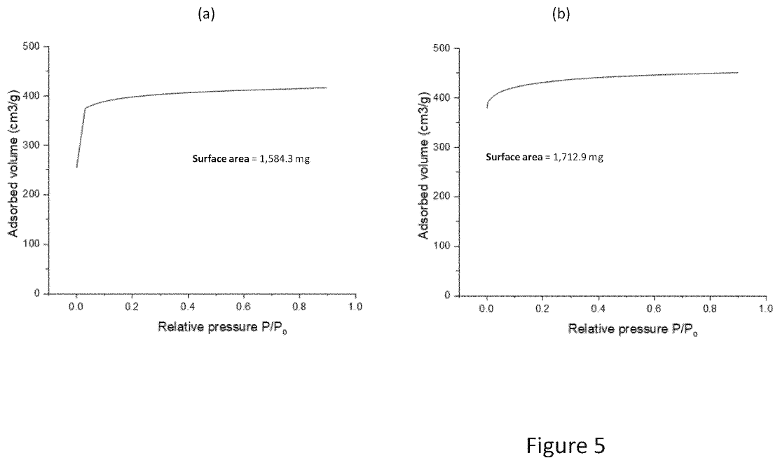

FIG. 6 shows CO₂ uptake quantified using thermo gravimetric analysis (TGA) of particles produced by a mixing reactor according to the invention and a prior art reactor.

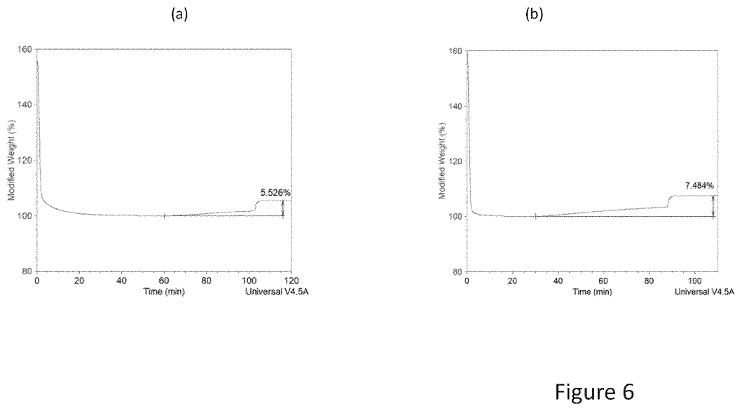

FIG. 7 shows thermo gravimetric analysis decomposition plots for particles produced by a mixing reactor according to the invention and a prior art reactor.

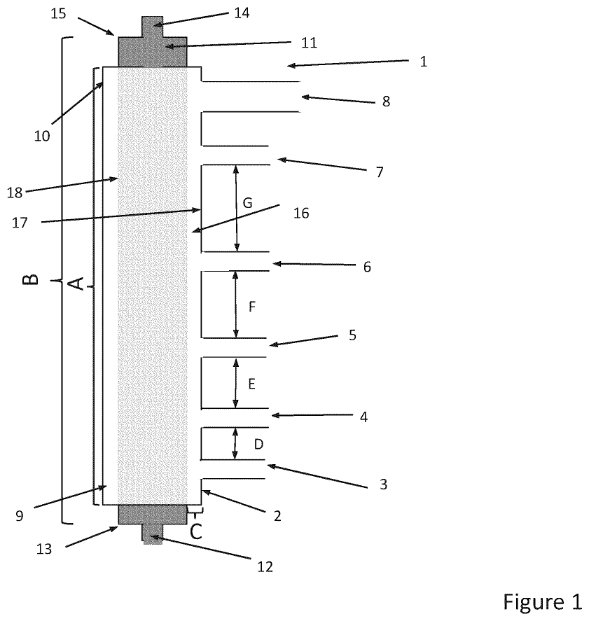

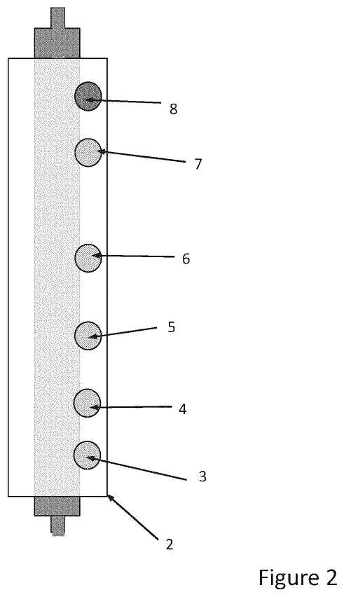

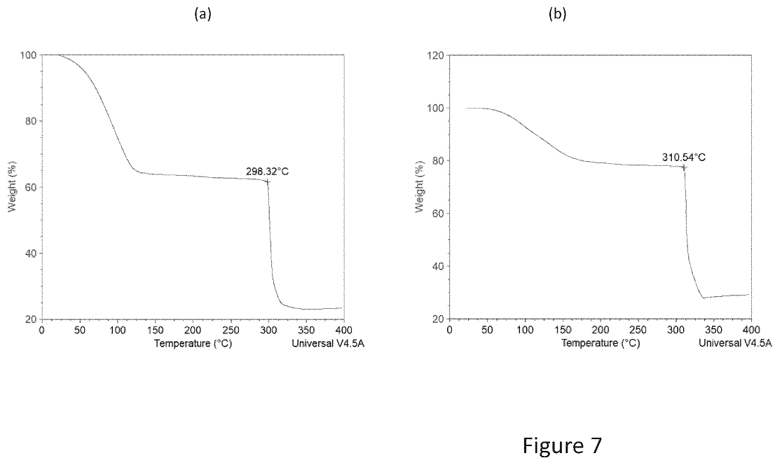

FIGS. 1 and 2 show a mixing reactor 1 in accordance with a first aspect of the invention. It comprises a first body 2 having a first inlet 3 at a first end 9 of the first body 2 and an outlet 8 at a second end 10 of the first body 2. The first body 2 has further inlets, such as a second inlet 4, a third inlet 5, a fourth inlet 6 and a fifth inlet 7 aligned between the first inlet 3 and the outlet 8 along the length of the first body 2. The first body 2 is elongate and has a length A.

The reactor is used with the second end 10 uppermost (that is as if the accompanying drawings were viewed vertically).

The reactor further comprises a second body 11 (e.g. a metal body) having an inlet 12 a first end 13 of the second body 11 and an outlet 14 at a second end 15 of the second body 11. The second body 11 is generally elongate and has a length B.

An inner passage 16 is defined between the inner surface 17 of the first body 2 and the outer surface 18 of the second body 11. The inner passage 16 runs along the length of the first body 2. The inner passage has a width C defined by the distance from the inner surface 17 of the first body 2 to the outer surface 18 of the second body 11.

In FIGS. 1 and 2 the distance between inlets of the first body 2 increases with inlet number. The first distance D from the first inlet 3 of the first body to the second inlet 4 is smaller than the second distance E from the second inlet 4 to the third inlet 5, this second distance E is also smaller than the third distance F from the third inlet 5 to the fourth inlet 6, this third distance F is also smaller than the fourth distance G from the fourth inlet 6 to the fifth inlet 7.

As can be seen in more detail in FIG. 2 of the accompanying drawings, inlets 3-7 and outlet 8 of the first body 2 are aligned and spaced along the length on the first body 2.

Thus, if a metal salt solution is introduced into the first inlet 3, and a ligand solution is introduced into second to fifth inlets 4, 5, 6, 7, the swirl induced would lead to mixing of the metal salt solution and the ligand solution. The mixing is consistent and thorough, leading to a satisfactory yield of consistent nanoparticles or MOFs. The swirl and consequent mixing continues as the ligand solution is introduced into second to fifth inlets 4, 5, 6, 7. There is no need to employ mechanical impellers or the like. The particle suspension can then be extracted from the outlet 8 of the first body.

A heated or cooled liquid enters the second body 11 through the inlet 12 of the second body 11 and pass through the second body 11 to control the core temperature and exits the second body 11 through the outlet 14 of the second body 11.

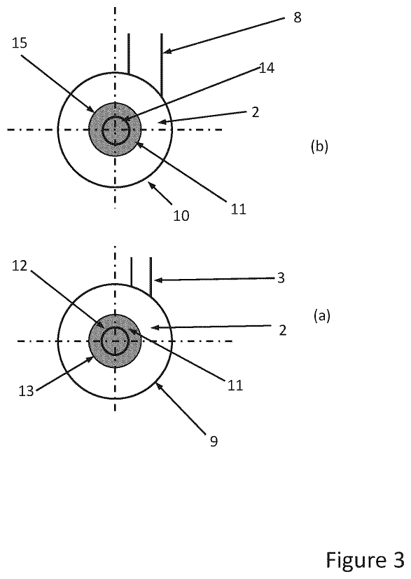

FIG. 3 shows front views of both ends of the mixing reactor 1. In FIG. 3(a) it can be seen the first end 9 of the first body 2, the first end 13 of the second body 11 having an inlet 12, and the first inlet 3 of the first body 2 introducing fluid tangentially into the inner passage 16. FIG. 3(b) shows the second end 10 of the first body 2, the second end 15 of the second body 11 having an outlet 14, and the outlet 8 of the first body 2 being tangential relative to the cross-section centre of the first body 2.

The position of the two or more inlets and outlet of the first body 2 can be varied around the first body's circumference, as long as the tangential element of the inlets is still maintained.

Furthermore, we have found that the reactor of the present invention produces larger particles than the existing continuous-flow reactors as demonstrated by the SEM image analysis of FIG. 3. Furthermore, particles made with the reactor of the present invention also have a greater CO₂ uptake, greater surface area and a higher thermal decomposition temperature.

It can be seen that the present reactor provides little opportunity for particle accumulation and/or lining of internal surfaces of the reactor. The present design allows for a reactor that is completely free of zones which may allow particle accumulation.

The mixing reactor 1 can be used in series with various other equipment without deleterious effect on the advantages it provides.

### EXAMPLE

The performance of the mixing reactor of the present invention for the preparation of the metal-organic framework (MOF) was evaluated and compared to MOF made using a known continuous-flow reactor as described in WO2015/075439

### Example 1

All chemicals were used as purchased with no further purification. 58.99 g trimesic acid (95%) was added to a 10 L drum along with 82.42 g triethylamine (95%), 2 L of methanol and 6 L deionised water, making solution A. In a 5 L drum, 98.6 g copper nitrate (98%) was added along with 2 L deionised water, making solution B. Solutions were stirred until both were free of any solid material and homogenous.

### (a) Prior Art Continuous-Flow Reactor

Inlet tubes from both pumps on the continuous-flow reactor were placed into the corresponding solutions and flow rates of 2,000 mL/min (solution A) and 1000 mL/min (solution B) set. The solutions were pumped through the reactor and the reaction product collected. Once collected, the samples were immediately centrifuged at 3,000 RPM for 5 minutes and the supernatant discarded. The isolated solid reaction product was redispersed/washed with methanol and allowed to settle for 24 hrs before a final centrifugation at 3,000 RPM for 5 minutes. The centrifuged solids were oven dried for 18 hr at 110° C. Each unactivated (pre-dry) sample of MOF (sample (a)) showed a cyan colour, but once activated (post-dry) the samples turned dark purple.

### (b) Reactor of the Present Invention

A reactor according to the present invention having four inlets was used.

Inlet tubes from all four pumps on the mixing reactor were placed into the corresponding solutions, where feed 1 was placed into the metal salt solution (solution B) and feeds 2, 3 and 4 were placed into the basic ligand and solution (solution A). The pumps were set at flow rates, of 600 mL min₋₁ for feed 1, and 800 mL min⁻¹ for feeds 2, 3 and 4 (i.e. total flow rate of 4 L min₋₁). The solutions were pumped through the reactor and the reaction product collected at the outlet feed. Once collected, the samples were immediately centrifuged at 3,000 RPM for 5 minutes and the supernatant discarded. The isolated solid reaction product was redispersed/washed with methanol, allowed to settle for 24 hrs, and centrifuged a second time at 3,000 RPM for 5 minutes. The supernatant was removed and the centrifuged solids oven dried for 18 hrs at 110° C. Each unactivated (pre-dry) sample of MOF (sample (b)) showed a cyan colour, but once activated (post-dry) the samples turned dark purple.

### Example 2

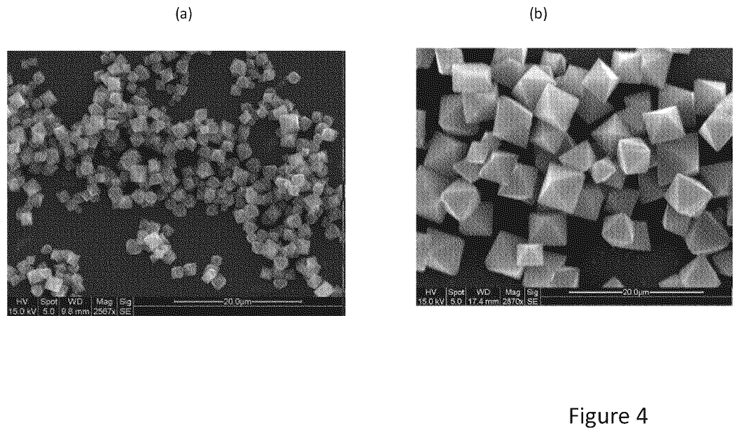

MOF (sample (a)) produced on the prior art continuous-flow reactor and MOF (sample (b)) produced on the mixing reactor of the present invention was analysed under scanning electron Microscopy (SEM). Micrographs are shown in FIG. 4. When both reactors are run at identical flow rates of 3 L/min, the reactor of the present invention produces larger particles than the existing continuous-flow reactor as demonstrated by the SEM image analysis.

### Example 3

MOF produced on the prior art continuous-flow reactor (sample (a)) and MOF produced on the mixing reactor of the present invention (sample (b)) was analysed by BET isotherm adsorption. When both reactors are run at identical flow rates of 3 L/min, sample (b) showed a higher BET surface area of 1,712.9 m²g⁻¹ vs. 1,584.3 m²g⁻¹ of the sample (a).

### Example 4

CO₂ uptake was quantified using thermo gravimetric analysis (TGA). 15% CO₂, 25° C., 100 mL min⁻¹ flow rate, activated at 150° C. for 30 minutes (sample (b) vs. 60 minutes (sample (a)).

Sample (b) has a higher CO₂ uptake of 7.5 wt. % compared to 5.5 wt. %.

### Example 5

TGA Decomposition analysis were carried out with air at 100 mL/min and heating rate of 10° C./min.

Sample (b) showed higher thermal decomposition temperature of 310° C. vs. 298° C. of sample (a).

1. A mixing reactor comprising a first body comprising two or more inlets and an outlet, and a second body placed concentrically inside the first body so as to define an inner passage formed by an inner surface of the first body and an outer surface of the second body, wherein the inner passage extends along a length of the first body, wherein the two or more inlets are spaced along the length of the first body, and wherein there is no mixing between a liquid passed through the second body and a liquid passing through the inner passage.

2. The mixing reactor of claim 1, wherein the first body comprises a first inlet at a first end of the first body and the outlet is at a second end of the first body.

3. The mixing reactor of claim 1, wherein the first body comprises between 2 and 10 inlets.

4. The mixing reactor of claim 1, wherein the two or more inlets of the first body are axially aligned on the first body.

5. The mixing reactor of claim 1, wherein each of the two or more inlets of the first body are arranged to introduce fluid into the passage at least partially tangentially relative to the common axis.

6. The mixing reactor of claim 5, wherein each inlet is arranged to introduce fluid into the passage within 15, 10, 5 or 1 degrees of tangential relative to the axis.

7. The mixing reactor of claim 1, wherein the first body comprises a first inlet, a second inlet, a third inlet and a fourth inlet consecutively and axially aligned along the length of the first body.

8. The mixing reactor of claim 1, wherein the distance between inlets along the length of the first body increases moving towards the outlet.

9. A cascade of mixing reactors, comprising:
a first mixing reactor comprising a first body comprising two or more inlets and an outlet, and a second body placed concentrically inside the first body so as to define an inner passage formed by an inner surface of the first body and an outer surface of the second body, wherein the inner passage extends along a length of the first body, wherein the two or more inlets are spaced along the length of the first body, and wherein there is no mixing between a liquid passed through the second body and a liquid passing through the inner passage; and
a second mixing reactor comprising a first body comprising two or more inlets and an outlet, and a second body placed concentrically inside the first body so as to define an inner passage formed by an inner surface of the first body and an outer surface of the second body, wherein the inner passage extends along a length of the first body, wherein the two or more inlets are spaced along the length of the first body, and wherein there is no mixing between a liquid passed through the second body and a liquid passing through the inner passage;
in which the outlet of the first body of the first mixing reactor is coupled to an inlet of the first body of the second mixing reactor.

10. The cascade of mixing reactors of claim 9, wherein the outlet of the first body of the first mixing reactor is coupled to a first inlet of the first body of the second mixing reactor.

11. A method of mixing two fluids using a mixing reactor comprising a first body comprising two or more inlets and an outlet, and a second body placed concentrically inside the first body so as to define an inner passage formed by an inner surface of the first body and an outer surface of the second body, wherein the inner passage extends along a length of the first body, wherein the two or more inlets are spaced along the length of the first body, and wherein there is no mixing between a liquid passed through the second body and a liquid passing through the inner passage,
the method comprising delivering a first fluid through one inlet of the first body of the mixing reactor, delivering a second fluid through one or more other inlets of the first body of the mixing reactor and extracting a mixed fluid from the outlet.

12. The method of claim 11, in which the first fluid is a metal salt solution.

13. The method of claim 11, in which the mixed fluid is a particle-bearing suspension.

14. The method of claim 13, in which the particles are nano-particles, or metal-organic framework (MOF) particles.

15. The method of claim 11, in which the reactor is used with the second end uppermost.

16. The method of claim 11, in which the second fluid is a solution, typically a ligand solution.

17. The method of claim 16, in which a concentration of the second fluid varies between different other inlets.

18. The method of claim 11, further comprising heating or cooling the mixed fluid as it passes or swirls through the inner passage formed by an inner surface of the first body and an outer surface of the second body.

19. The method of claim 11, further comprising delivering a third fluid through one or more inlets of the first body.

20. A cascade of mixing reactors, comprising a first mixing reactor and a second mixing reactor, wherein each of the first and second mixing reactors comprises a first body comprising two inlets and an outlet, and a second body placed concentrically inside the first body so as to define an inner passage formed by an inner surface of the first body and an outer surface of the second body, wherein the inner passage extends along a length of the first body, and wherein the outlet of the first body of the first mixing reactor is coupled to one inlet of the first body of the second mixing reactor.

21. The cascade of mixing reactors of claim 20 wherein the outlet of the first body of the first mixing reactor is coupled to a first inlet at the first end of the first body of the second mixing reactor.

22. A method of mixing two solutions, comprising introducing a first solution to a first inlet of a first reactor and a second solution to a second inlet of the first reactor, to produce a first mixed fluid at an outlet of the first reactor, and conveying the first mixed fluid to a first inlet of a second reactor and introducing further second solution to a second inlet of the second reactor, in which the concentrations of the second fluid introduced to the first and second reactors is different.
